(19) United States
(12) Patent Application Publication
(10) Pub. No.: US 2002/0013108 A1
(43) Pub. Date: Jan. 31, 2002

(54) Scented perfumed blotter

(76) Inventor: Sven Dobler, New York, NY (US)

Correspondence Address: PAUL M. DENK, 763 South New Ballas Rd., St. Louis, MO, 63141, US

(21) Appl. No.: 09/953,552

(22) Filed: Sep. 17, 2001

Related U.S. Application Data
(63) Continuation of application No. 09/188,156, filed on Nov. 7, 1998.
(60) Provisional application No. 60/069,776, filed on Dec. 16, 1997.

(51) Int. Cl. B32B 3/00; B32B 5/02; B32B 9/00; B32B 27/04; B32B 27/12; B32B 3/26

(52) U.S. Cl. 442/96; 442/59; 428/905

(57) ABSTRACT

A scented perfumed blotter, including a paperboard or polymer card, having a coating applied to its surface, at least with respect to the paper formed card, so that print or graphics can be applied thereto, or foil laminated thereon, to provide an enhanced display for promoting the marketing of the fragrance. To the underside of the paperboard or plastic card, there may be laminated thereto, a highly porous sheet of paper, adhered thereto by means of an adhesive, or pressure sensitive adhesive, that may be laminated by means of roller or other application, so that when the card is held by the sales person, or the prospective customer, as in-store, a fragrance may be sprayed thereto, upon the porous under surface, and provide a ready scent for detection by the customer to determine her acceptance of the applied fragrance. Or, the card, as sprayed, can be simply rubbed upon the surface of the skin, to provide a minor application of the fragrance, for ready detection. In addition, the porous laminate surface of the card may be pre-sprayed, or have pre-applied thereto, the fragrance oil, so that when it is received as a direct mail solicitation, the addressee may simply rub it, to release its fragrance, or apply it through a rubbing motion to the surface of the skin, in order to detect the fragrance of the sample.

### BACKGROUND OF THE INVENTION

As is generally known, this current day, an unscented card or blotter is used in department stores to spray fragrance and provide a sampling of scented perfume to the customer. The card normally is made of an un-coated paper stock, since the clay coatings repel the fragrance spray and does not hold the fragrance for delivery. The one way known to use a coated stock card is to silk screen a fragrance slurry and create what is generally referred to as the “scratch and sniff” card. Another alternative is to apply a pressure sensitive label onto a coated card where the fragrance is incorporated into the label.

From a marketing standpoint, a coated card is preferable to an un-coated card, since the graphic reproduction of the customer's art is far superior than when applied to an un-coated stock. The colors are more brilliant and shiny on the coated stock. This “scratch and sniff” card, and the label card, have the advantage over traditional blotters in that they can be printed with multi colors. The fragrance treatment is on top of the card, and the ink odor does not interfere with the fragrance application. With traditional un-coated spray cards, marketers are often limited to one or two colors, since the fragrance spray is required to penetrate into the stock where it can sometimes mix with the ink, and distort the fragrance rendition.

Blotter cards have also often been pre-scented, and have constituted the main sampling device for use for direct mail and in-store sampling. This process had been used earlier, when a product identified as the Scentstrip was introduced to the market, for use for this purpose. The new Scentstrip product has replaced many of the pre-scented blotters in the direct mail category, because they offer the ability to transfer the fragrance treatment to the customer for personalized application.

### BRIEF SUMMARY OF THE INVENTION

It is the principal object of this current invention to provide a scented perfumed blotter, for use for a variety of purposes, either for in-store usage, providing a scented card for application, or for use for direct mail and mail order business.

This current invention includes a paperboard card, formed as a blotter, that has a coated surface for optimal graphic reproduction. The blotter can be printed with multi-color, without any interference from the ink odor, so that the perfumed fragrance spray is not interfered or detracted from by any other detrimental odors, such as that of the ink, or the adhesive holding the paperboard together. This new invention provides a blotter, which has a sampling of the fragrance applied to it, and allows for the transfer of the fragrance to the skin for a personalized try on application.

It is, therefore, another object of this invention to provide a scented blotter, for delivery of perfume scents to the user, wherein the odor of the perfume is not interfered with by any of the other ingredients used in the preparation of the blotter, such as the printed graphics, the odor of the inks used therein, the aroma of the paperboard, or the adhesive used to hold it intact.

Another object of this invention is to provide a scented blotter that can be printed with multi-colored inks, and furnish an enhanced gloss and appearance when completed, without interfering with the scent of the perfumed sample.

A further object of this invention is to provide a scented blotter, treated with a particular perfume, to allow for transfer of fragrance to the skin for personalized sampling.

Another object of this invention is to provide a blotter that does not require any modification or alteration of the fragrance, during its application, nor does it involve the loss of any elements of the original fragrance, unlike the type of samples that incorporate the “scratch and sniff” procedure.

A further object of this invention is the preparation of a blotter, treated with fragrance, that is only absorbed in the porous back fiber area of the card, the required fragrance oil being applied in a manner distinct from the conventional pre-scented cards.

These and other objects will become more apparent to those skilled in the art upon reviewing the summary herein, and upon undertaking a study of the description of its preferred embodiment, in view of the drawing.

### BRIEF DESCRIPTION OF THE DRAWINGS

In referring to the drawings, FIG. 1 is a view of the scented perfumed blotter of this invention, of the front coated portion of the card, printed or embossed with data, as noted;

FIG. 2 is a view of the soft textured and porous backside of the blotter, as shown in FIG. 1; and

FIG. 3 is a sectional view of the blotter showing the various laminates in its formation.

### DESCRIPTION OF THE PREFERRED EMBODIMENT

In the fabrication of the scented perfumed blotter of this invention, the paperboard stock material is formed as a laminate of a synthetic, non-woven fiber material, applied to the back side of a coated stock. This procedure is performed by a roll to roll operation, as known in the paperboard art. The roll is then slit and sheeted, and is ready for normal printing and finishing procedures such as through embossing, dye cutting, or foil stamping, in order to provide for enhanced graphics to the observable surface of the formed blotter. This upper coated side of the stock is what may be printed, and is readily receptive of the inks that are used in such graphical printing process. The backside of the card, as thus prepared, has a micro-fiber layer of paper, that is more porous, and which can readily accept and absorb, in addition to hold, and readily release, the fragrance sprayed onto the card at the department store counter, or one which has been pre-scented at the factory, for direct mail applications to prospective customers. By merely swiping the fiber back portion of the card, onto the surface of the skin, the fragrance now readily transfers to the skin of the person testing the fragrance, and allows for a personalized try-on of the scented perfume.

As can be seen in the drawings, FIG. 1 discloses the front side of the scented perfumed blotter, with the front coated side of the paper stock having the graphics supplied thereto, or the embossment, and which provides a pleasing appearance to the blotter, for either use in store, or for direct mailing purposes, to provide sampling to prospective customers, and to furnish a direct and actual sampling of the scented perfume being promoted.

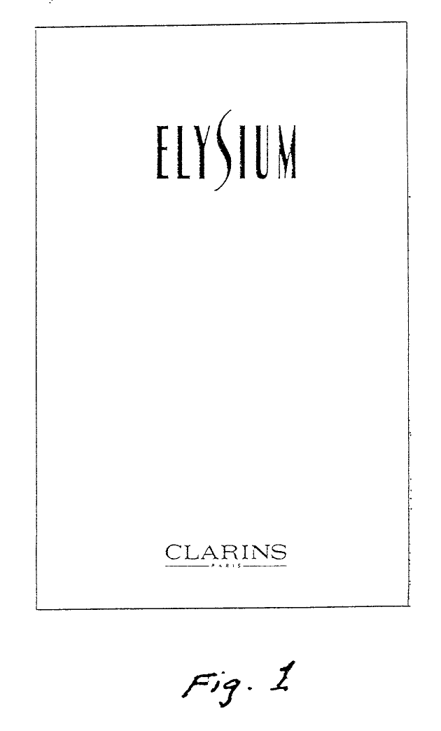

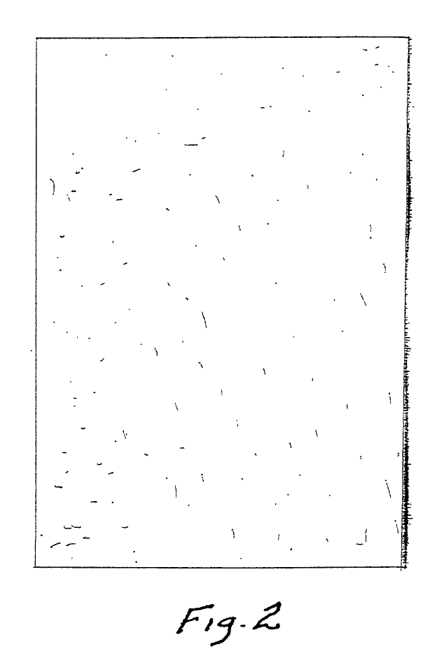

FIG. 2 discloses the scented perfumed blotter, upon its backside, and which furnishes a much more porous almost tissue-like texture, that is laminated to the backside of the blotter-like card, and functions just like a blotter, to accept either the spray on of the scented perfume, or to have it pre-applied thereto, and which can be released, upon the skin, when the card is rubbed contiguously there against. Thus, the inks, clay, and other coating that is applied to the front side of the card, in order to add to its enhanced graphics, and pleasing appearance, has no effect upon the application of the fragrance to the backside, where it is desired that the perfume will release its unadulterated scent, to the user, to provide a very accurate aroma of the fragrance being promoted and marketed.

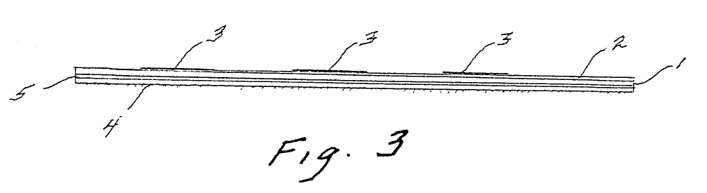

FIG. 3 discloses a sketch of a card, along a side view, and as can be seen, the card includes the upper layer of paperboard stock, as at 1, formed into the card configuration. To the surface of the card, there is applied a coating of the clay or other print accepting composition, normally of clay, and which forms the card into a coated stock, as can be seen at 2. As a result of the coated stock, along its upper surface, having a harder texture, it can more readily accept the print, by ink, dyes, or other coloring, as at 3, to enhance the graphics of the card. To the underside of the paper card 1, there is roller applied a more porous or tissue textured laminate, as at 4, and which is adhered thereto, by roller application, as previously explained, by means of a coating of adhesive 5. As can be noted, the tissue has a very porous surface, and can readily absorb, either by spray on, the fragrance being tested, as in-store, or the fragrance can be applied thereto, and the card may be used as a direct mail application, which when received by the addressee, can be used for testing of the fragrance involved. Since the oils of the fragrance are readily absorbed into the porous surface of the laminate 4, and since the fragrance oil has a lasting or staying condition, and does not dry or lose its aroma, a mere rubbing of this fragrance treated laminate against the skin, by the recipient, can release the aroma of the fragrance, directly upon the skin, and provide a ready and direct sense to the olfactory of the user, of the smell of the fragrance, in an effort to promote its eventual sale in the store, or by catalog.

This is an example of usage of the scented perfumed blotter of this invention, how the enhanced graphics can be readily preserved upon application to a paperboard card of this design, and which can be further pre-scented, or scented at the store, through spray application, for ready olfactory acceptance by the customer, in an effort to market this particular scented fragrance.

As can be understood, the card may also be fabricated, at least with respect to that layer of the card 1, in lieu of paperboard, it could be formed as a polymer, and have various inks or coatings applied thereto, to furnish enhanced graphics, or along its upper surface it may have laminated thereto a foil, or other means for enhancing the appearance of the blotter, and increase its acceptance by the prospective customer. Then, to the under side of the polymer type of card 1 could be applied the laminate 4, through roller application, or by other application, adhered thereto by either an adhesive 5, or some other type of pressure sensitive adhesive. These are examples of how the versatile scented blotter of this invention can be formed, for ready usage and application as a marketing tool.

Variations or modifications to the subject matter of this invention may occur to those skilled in the art upon reviewing the description of the development as set forth herein. Such variations or modifications, if within the spirit of this invention, are

intended to be encompassed within the scope of this invention, as described. The description of the preferred embodiment as set forth herein, and as shown in the drawings, is set forth for illustrative purposes only.

1. A scented perfumed blotter which accepts a perfume sample; the blotter including a card having an upper surface and a lower surface, and a laminate applied to the lower surface of the card; the laminate being made of a material which will absorb a fragrance sample when a sample is applied to the laminate, said laminate being porous.

2. The blotter of claim 1 wherein the card is made of paperboard or polymer and is adapted to have graphics printed or embossed on the upper surface thereof.

3. The blotter of claim 2 wherein the card is a paperboard card, the blotter including a coating applied to the upper surface of the card, the coating being capable of being printed upon.

4. The scented perfumed blotter of claim 1 wherein the laminate has a porosity greater than that of the card.
